(19) United States
(12) Patent Application Publication
(10) Pub. No.: US 2015/0172795 A1
(43) Pub. Date: Jun. 18, 2015

(54) LOUDSPEAKER SYSTEM WITH SEMI-CIRCULAR LOUDSPEAKER CONFIGURATION

(71) Applicant: Davies Roberts, West Sussex (GB)

(72) Inventor: Davies Roberts, West Sussex (GB)

(73) Assignee: FLARE AUDIO HOLDINGS LIMITED, London (GB)

(21) Appl. No.: 14/239,484

(22) PCT Filed: Aug. 20, 2012
(86) PCT No.: PCT/GB2012/052033

§ 371 Date: Apr. 17, 2014

(30) Foreign Application Priority Data
Aug. 19, 2011 (GB) 1114353.4

(51) Int. Cl. H04R 1/00

(52) U.S. Cl. CPC H04R 1/00

(57) ABSTRACT

A sub bass, bass and low mid frequency loudspeaker incorporates multiple loudspeaker drivers arranged in a semi-circle configuration contained within an enclosure. The symmetric multi-horn invention enables all associated loudspeaker drivers to couple their energy in phase coherence and time alignment to form one coherent sound wave upon exit of the loudspeaker. Low frequency sensitivity is greatly increased upon exit from the loudspeaker without creating resonance or transient decay. Additional loudspeakers can be added to form a larger system that maintains phase coherence and time alignment over all the loudspeakers contained in the system. Each additional loudspeaker added to the system increases low frequency sensitivity.

### TECHNICAL FIELD

The present disclosure relates to a loudspeaker system. In more detail, it relates to equipment for use in sound reinforcement and reproduction, more specifically, to a loudspeaker enclosure and system for sub bass, bass and low mid frequencies between 1 Hz and 850 Hz.

### BACKGROUND

There have been many designs of loudspeaker enclosures for sound reinforcement of low mid and bass frequencies. The prior art includes a variety of designs with the most popular being front loaded (infinite baffle), bass reflex, band pass and horn loaded. These prior art designs have their advantages and disadvantages but in general suit specific styles of music and have associated problems when working together to form larger sound systems.

Front loaded or infinite baffle designs produce accurate sound reproduction but lack lower frequency strength and controlled directionality. This is due to the loudspeaker driver lacking in the ability to couple effectively without the use of some form of acoustic transformer to guide sound wave energy. Sound waves produced by this design are not focused and lack any form of directional control, reducing the ability for sound to travel long distances.

Bass reflex designs provide increased low frequency sensitivity when compared to front loaded but suffer from increased transient decay and resonance. Transient decay and resonance is created by the opposite phase of the sound wave which is produced by the rear of the loudspeaker driver reflecting within the enclosure in order to enhance bass frequencies. When this secondary sound wave emanates from the bass reflex port later than the sound wave produced by the front of the loudspeaker driver it causes multiple sound wave arrivals to the sound field. This transient decay and resonance damages overall coherence and intelligibility in the bass frequencies produced by this design.

Band pass designs produce very high bass frequency response through the use of a resonant chamber. This design creates a large amount of resonance within the enclosure which provides an enhanced bass response. The opposite phase of the loudspeaker driver is sealed within a second internal chamber contained within the enclosure to stop frequency cancellation from the opposite phase of the loudspeaker driver. This design lacks definition which is due to the sound waves reflecting inside the enclosure, destroying intelligibility and resulting in an undefined sound field being produced.

Horn loaded designs produce high sensitivity over a wide range of frequencies and can be adapted to suit specific designs of loudspeaker and styles of material being played. Horn loaded bass enclosures are generally designed to produce frequencies from 35 Hz-125 Hz and use a large loudspeaker driver in order to produce the required bass frequencies.

Designs vary but in general the opposite phase of the loudspeaker driver is sealed within a secondary internal chamber to stop interference and enable greater power to be used without the loudspeaker driver reaching its limit of deflection. Horn loaded bass designs produce enhanced bass frequency response over a wide frequency range and have the ability to throw long distances due to the large horn coupling the sound wave effectively.

This design creates resonance within the large horn as the sound wave becomes reflected within the large space which causes the sound wave to exit non-coherently. When additional loudspeakers are added to increase a systems size (in phase and out of phase) frequencies collide between separate loudspeakers unpredictably on exit causing a lack of definition, lack of linearity and reduction of sensitivity to the overall sound field. This creates unpredictable audio nodes over a wide area which affects linearity resulting in an increased level of bass in some parts and a reduction of bass in others.

In general horn loaded bass designs are larger and heavier than other designs.

Prior art designs of sub bass and bass frequency loudspeakers lack the capability to work together in coherent phase and time alignment when forming a larger sound system. At events such as music concerts this causes the overall sound field to lack linearity and proper definition of bass frequencies. This is caused by destructive and constructive interference occurring between multiple bass loudspeakers, comb filtering and the lack of proper time alignment between the multiple drivers.

Sound waves travel in a circle formation so if a sound system is to be setup to use multiple loudspeakers it needs to have the ability to control its sound wave dispersion in a similar way to natural wave formation in order to produce high quality sound.

If a sound system is to achieve a truly high quality sound field multiple loudspeakers need to have the capability to couple their energy together and focus that energy over a prescribed sound field with a high degree of accuracy. The sound system must also ensure that all frequencies arrive simultaneously in one coherent sound wave. Time delays between loudspeakers of less than a millisecond can be detected by the human ear which appears to the listener as distortion or lack of definition.

The common way to try and correct interference and time alignment issues between multiple loudspeakers with larger prior art sound systems is with the use of electronic processing in the signal path. Processing the sound system electronically enables voltages to be increased or decreased at specific frequencies that are fed to the individual loudspeaker drivers. This electronic correction helps to mask resonance, increase weak frequencies lost by destructive interference and decrease strong frequencies created by constructive interference. This approach does enable a prior art sound system to achieve a flat frequency response, however, it also causes the transient attack and transient decay of the frequency adjusted to become reduced and lose phase coherence. Fast transient attack and fast transient decay is crucial to the overall definition of sound. Transient attack represents the front portion of a sound wave whilst transient decay represents the rear portion. Any reduction to transient attack or decay of a sound wave from the source material causes the sound to become less defined resulting in a reduction of definition and quality.

This adjustment of phase coherence by electronic processing causes sound at the adjusted frequency to become out of phase with the majority which alters the effective phase angle at that frequency. This reduces definition, transient attack and transient decay which results in a reduction of audio quality at the adjusted frequency.

Electronic processing is also used to mask the effects of resonance in prior art designs by reducing the sound level of the affected resonant frequency. However, this electronic mask cannot repair the damage done by resonance, meaning that detail in those frequencies is lost and cannot be replaced electronically.

### SUMMARY

Aspects of the present disclosure are set out in the claims.

According to one aspect, there is provided a low mid and bass loudspeaker, which produces a greatly increased sub bass and bass frequency sensitivity with substantially lower resonance when compared to prior art. The invention overcomes the issue of a non-coherent sound field enabling multiple loudspeakers of this invention to be used together in coherent phase and time alignment over the entire sound field.

The invention incorporates multiple loudspeaker drivers arranged in a semi-circle configuration contained within an enclosure that is acoustically open to the front. Each loudspeaker driver produces separate sound waves that propagate into a dedicated sound channel which is sealed to the rear and each side whilst being acoustically open to the front. These said separate sound channels are aligned through an arrangement that mimics natural sound wave propagation in order to produce one time aligned and phase coherent sound wave at the acoustically open front. This combined sound wave produces greatly increased lower frequency sensitivity with a very high degree of definition.

Low frequency sensitivity is increased as the combined sound wave exits the loudspeaker. With each additional loudspeaker added to the system the low frequency sensitivity continues to increase. This combined sound wave acts as one coherent force able to reproduce defined sub bass, bass and low mid frequencies without creating resonance or transient decay.

Overall efficiency is increased as each individual sound wave coherently combines on exit to form one coherent sound wave which reduces static particle friction between the separated waves. Efficiency is further increased by the minimal internal surface area inside the separated sound channels which leads to a reduction in friction as the sound waves travel through the enclosure.

The invention allows further loudspeakers of a similar design to be added on top and to both the sides whilst maintaining coherent phase and time alignment of every loudspeaker and every loudspeaker driver.

The semi-circle arrangement of the loudspeaker drivers combined with the lack of a resonant chamber to enhance low frequency sensitivity minimises the external size of the enclosure, reducing the overall weight.

### BRIEF DESCRIPTION OF THE DRAWINGS

Embodiments of the disclosure are now be described, by way of example only, with reference to the accompanying drawings.

FIG. 1 is a top cut through cross section view of a loudspeaker enclosure with a fanned dispersion arrangement.

FIG. 2 is a top cut through cross section view of a loudspeaker enclosure with a fanned dispersion arrangement, the enclosure being half that shown in FIG. 1.

FIG. 3 is a top cut through cross section view of a loudspeaker enclosure with a straight dispersion arrangement.

FIG. 4 is a top cut through cross section view of a loudspeaker enclosure with a straight dispersion arrangement, the enclosure being half that shown in FIG. 3.

FIG. 5 is a top cut through cross section view of a loudspeaker system comprising multiple loudspeaker enclosures as shown in FIGS. 2 and 3.

FIG. 6 is a schematic cross-section through a loudspeaker in accordance with another embodiment.

FIG. 7 is a schematic cross-section through a loudspeaker in accordance with another embodiment.

FIG. 8 is a schematic cross-section through a loudspeaker in accordance with another embodiment.

FIG. 9 is a schematic cross-section through a loudspeaker in accordance with another embodiment.

### DETAILED DESCRIPTION

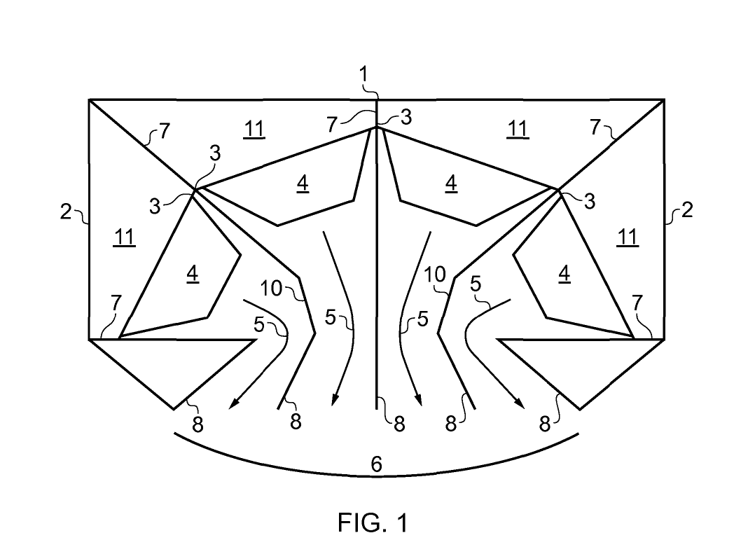

Referring to FIG. 1, in a first embodiment, there is provided a sub bass, bass and low mid frequency (1 Hz 850 Hz) loudspeaker enclosure. In FIG. 1, top and bottom pieces are solid flat panels, which in the drawing have been removed and are not shown in order to reveal vertical parts, detailed as follows.

A solid rear wall 1 has removable door panels (not shown) to allow loudspeaker driver access. Solid side walls 2 also have removable door panels (not shown) to allow for loudspeaker driver access. Driver baffles 3 mount loudspeaker drivers 4. The loudspeaker drivers 4 are mounted in reverse to aid cooling, and through a hole cut in the baffle 3 matching the size required by the driver 4. Channel dividers 7, 8, 10 keep the sound waves of each loudspeaker driver 4 in separate sections. This stops sound interference between each of the loudspeaker drivers 4. Sound waves produced from each loudspeaker driver 4 travel toward the centre and forward as shown by lines 5. Each sound wave is guided through a channel by channel dividers 7, 10 proximal to the loudspeaker drivers 4, which lines up each sound wave coherently into an arrangement created by channel dividers 8 at an exit 6 from the loudspeaker enclosure. This arrangement correctly forms each separate sound channel in time and phase alignment to form one coherent sound wave at the exit 6.

The loudspeaker drivers 4 are arranged in a semi-circle arrangement with channel dividers 7 separating each channel. The semi-circle arrangement can also be thought of as an arc formation. As can be seen from the drawings, the concave side of the arc formation faces the exit 6 whereas the convex side of the arc faces rear wall 1. In other words, the channels extend from the drivers towards the inside of the semi-circular configuration.

The channel dividers 7 also form the side channels for the drivers 4 at each side of the loudspeaker enclosure. It is useful for the angle of the baffles 3 to follow a semi-circle arrangement. The angle between each channel on the semi-circle can be increased or decreased to suit alternative designs and sizes as required.

The channels run between the drivers 4 and exit 6, and exits of the respective channels are positioned adjacent to each other. The length of each channel is substantially the same such that drivers 4 are substantially acoustically equidistant from exit 6.

By arranging the drivers 4 such that they are acoustically equidistant from the exit 6 a natural time-alignment in the output of the drivers 4 is achieved.

It will be apparent that symmetric arrangements are particularly useful in order to produce a natural time-alignment; arrangements such as triangles, squares, arcs, hemispheres etc. may all be used. However, it is also possible that asymmetric arrangements might be employed.

The loudspeaker drivers 4 each comprise a cone adapted to produce acoustic energy. The cone faces along an axis the same as its axis of symmetry. Each of the cones moves a volume of air proportional to a cross-sectional surface area of a projection along this axis. Each exit from the channels also has a cross-sectional surface area, which may be calculated in the present embodiment by multiplying the width of the exit by the height of the exit.

The cross-sectional area of a channel exit is less than the cross-sectional surface area of the cone, projected along the axis, of the driver housed in the respective channel.

In the present embodiment fours speaker drivers are employed, but it will be apparent to a person skilled in the art that any suitable number of speaker drivers might be used.

The angle between each pair of adjacent drivers 15 is substantially identical such that the axes along which drivers 15 project acoustic energy converge at a point within loudspeaker enclosure 14. In the present embodiment this arrangement has been found desirable so as to mimic the acoustic energy provided by the drivers originating from a single point when loudspeaker system 9 is in use. However, arrangements where the axes of the drivers do not converge on a single point, or converge at a point outside of the enclosure have also been found to work.

Multiple loudspeaker enclosures according to the first embodiment can be stacked vertically to increase the overall sound system size whilst maintaining correct time and phase coherence.

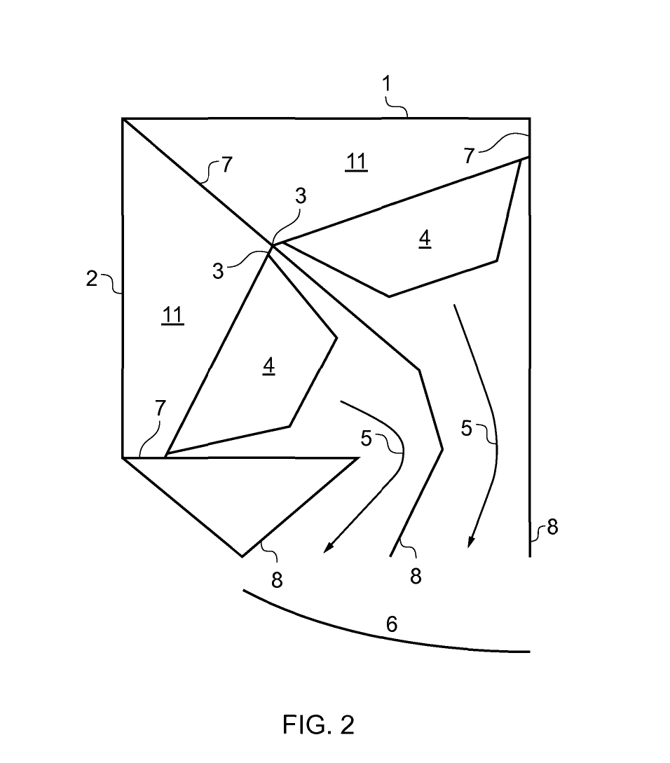

Referring to FIG. 2, in a second embodiment, a loudspeaker enclosure is provided that has an overall design that is half that of the loudspeaker enclosure according to the first embodiment. The construction method is the same as that for the first embodiment, with the exception of it being half the horizontal size. Multiple loudspeaker enclosures according to the second embodiment can be stacked vertically or two placed side by side in mirror formation to form a complete loudspeaker enclosure according to the first embodiment. This enables an increase in overall sound system size whilst maintaining correct time and phase coherence of the entire system.

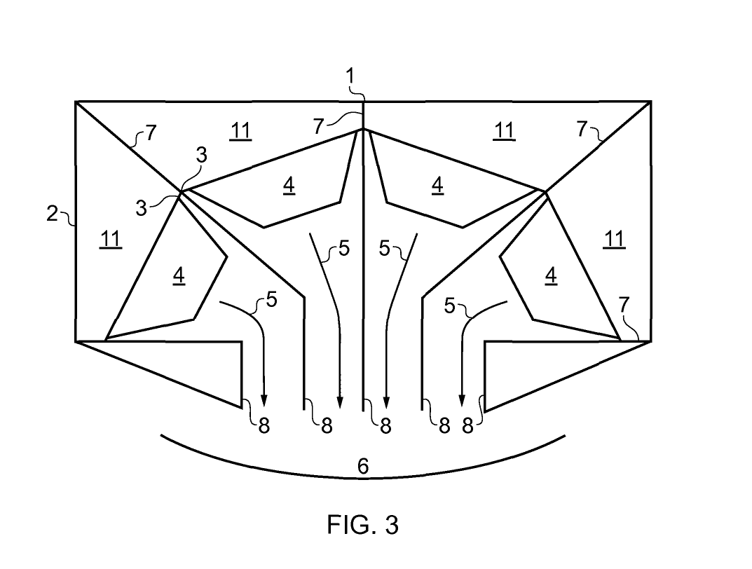

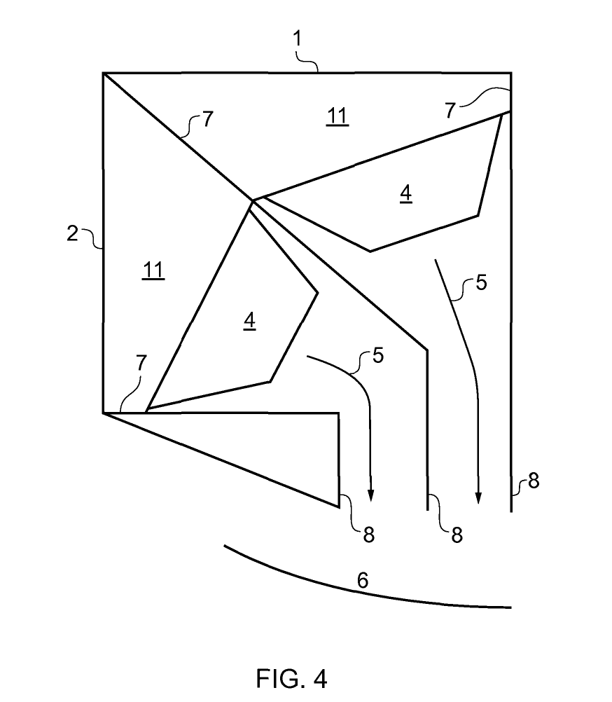

Referring to FIG. 3, in a third embodiment a loudspeaker enclosure is provided that is similar to that of the first embodiment, except that is has a straight exit channel arrangement. Similarly, referring to FIG. 4, in a fourth embodiment a loudspeaker enclosure is provided that is similar to that of the second embodiment, except that it has a straight channel exit arrangement. This allows multiple loudspeaker enclosures of the third or fourth embodiments to be setup alongside and on top of each other.

One loudspeaker enclosure of the second embodiment could be setup on each end in mirror formation to mimic natural sound wave formation. This would allow the sound system to increase in size both vertically and horizontally whilst maintaining correct time and phase coherence over the entire system as shown in FIG. 5.

It has been found that compressing the sound wave channels inside the enclosure as shown by channel dividers 7 at an angle similar to that of the loudspeaker driver's cone (not shown) reduces sound resonance and increases efficiency.

The areas 11 behind each of the loudspeaker drivers 4 are sealed and air tight. Sealing this area 11 enables greater power to be put though the loudspeaker driver 4 without reaching its limit of displacement. This sealing also prevents the negative phase of the sound wave created by the loudspeaker driver 4 interfering with the positive sound wave.

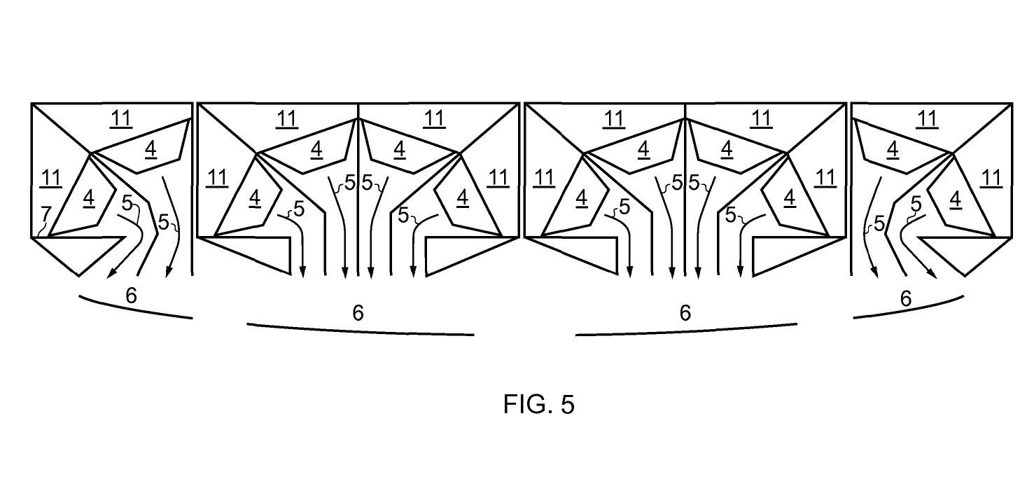

Referring to FIG. 6, in a further embodiment, a loudspeaker system comprises four reverse-mounted drivers 4 contained within a loudspeaker enclosure, mounted in a double semi-circular configuration. In this embodiment, the semi-circular configuration comprises the drivers being placed around the entire circumference of a circle, and may therefore be thought of as double a true semi-circle. Indeed, in this embodiment, as there are four drivers equally spaced from one another, the arrangement of the drivers is square. The enclosure comprises channel walls 7 such that each driver 4 is partitioned into its own individual channel. However, the present embodiment differs from those discussed before in that the acoustic energy exits from channel exits 10 of loudspeaker enclosure at ninety degrees to the axes of drivers 4.

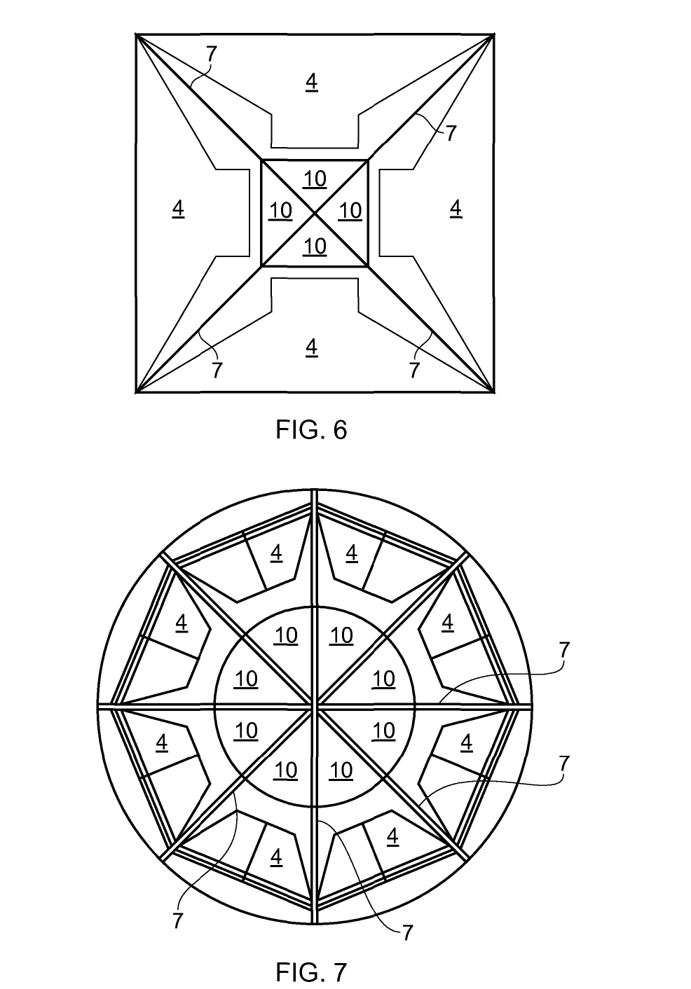

Referring to FIG. 7, in a further embodiment, a loudspeaker system is arranged in a similar formation to that of the loudspeaker system of the embodiment described with reference to FIG. 6, except that eight drivers 4 are provided instead of four. This means that the semi-circular configuration becomes an octagon, instead of four drivers 4 being positioned in a square. Once more, the system comprises channel walls 7 such that each driver is partitioned into its own individual channel. The acoustic energy exits from adjacent channel exits 10 of loudspeaker enclosure at ninety degrees to the axes of drivers 4.

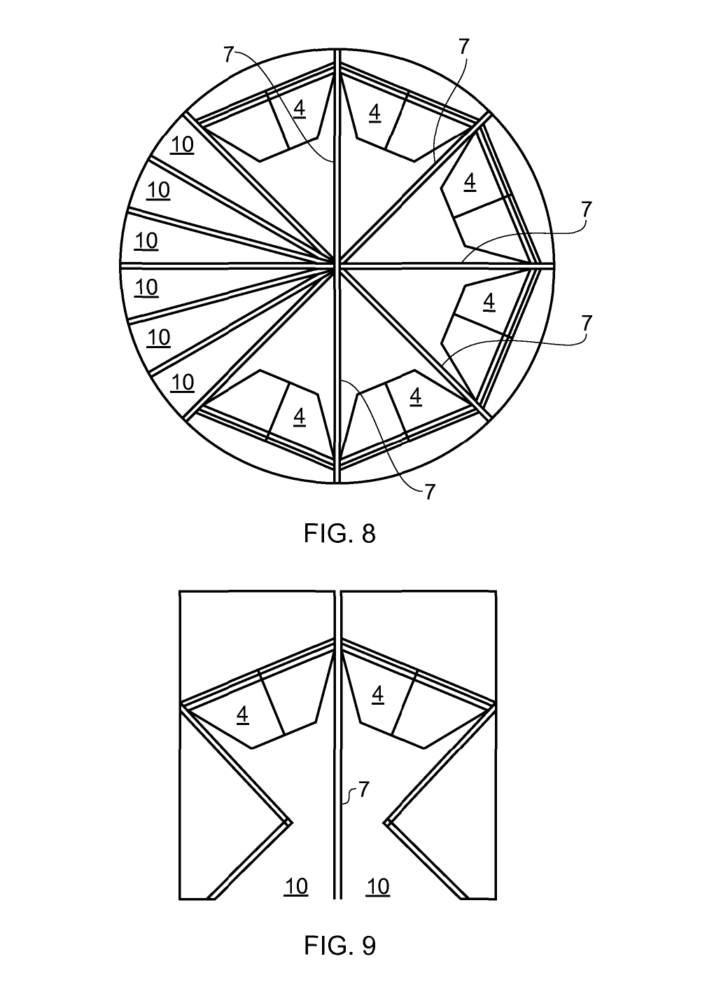

Referring to FIG. 8, in yet a further embodiment, a loudspeaker system comprises a plurality of drivers 4 arranged in an extended semi-circular configuration within a loudspeaker enclosure. In this embodiment, the semi-circular configuration comprises the drivers being placed along three-quarters of a circumference of a circle, and may therefore be thought of as extended in comparison to a true semi-circle. The loudspeaker enclosure is partitioned by channel walls 7 into a plurality of channels, each housing a separate driver 4. Acoustic energy from the drivers 4 may exit enclosure via adjacent channel exits 10 at a sound dispersing area.

Finally, referring to FIG. 9, in yet a further embodiment, a loudspeaker system comprises two drivers 4 arranged in a truncated semi-circular configuration within a loudspeaker enclosure. In this embodiment, the semi-circular configuration comprises the drivers being placed along a quarter of a circumference of a circle, and may therefore be thought of as truncated in comparison to a true semi-circle. The loudspeaker enclosure is partitioned by a channel wall 7 into two separate channels, each housing a separate driver 4. Acoustic energy from drivers 4 may exit enclosure via adjacent channel exits 10 at a sound dispersing area.

It is clear that many variations on the arrangement of the drivers and the sound dispersing area are possible.

In all of the embodiments disclosed in the present application each driver 15 has a separate acoustic channel 17. This is by far the preferred arrangement as housing more than one driver in a single channel would result in interference and loss of sound quality. However, it may be possible to house more than one driver in a single channel and still derive some increase in sound quality by providing a channel exit that has a smaller cross-sectional area than the total cross-sectional area of the driver cones housed within the channel.

It has been proved through testing that this invention produces very high sound definition at highly increased sensitivities in sub bass, bass and low mid frequencies with a greater control of dispersion that far exceeds that found in prior art.

It will be apparent that many variations are possible without departing from the scope of the present invention as set out in the appended claims.

1. A loudspeaker system for sounds in the frequency range 1 Hz to 850 Hz having a loudspeaker enclosure that incorporates multiple loudspeaker drivers arranged in a semi-circle configuration, each loudspeaker driver being separated into a separate sound channel that is sealed at each side whilst being acoustically open to the front, the semi-circle configuration of the loudspeaker drivers defining an arc having a concave side and the sound channels running between the concave side of the arc and the acoustically open front, each sound channel narrowing to a narrowest point located between the loudspeaker driver and the acoustically open front, and between the narrowest point and the acoustically open front each sound channel either widens or is of constant width, the sound channels being arranged in the semi-circle configuration in order to produce one time aligned and phase coherent sound wave at the acoustically open front.

2. (canceled)

3. (canceled)

4. (canceled)

5. (canceled)

6. (canceled)

7. A loudspeaker system as set forth in claim 1, wherein each loudspeaker driver has one or more cones adapted to direct acoustic energy along an axis; the acoustically open front comprises a plurality of adjacent exits of the sound channels, and the channel exits each have a cross-sectional area that is smaller than the surface area, projected along the axis, of the cone(s) of the driver housed within its respective channel.

8. A loudspeaker system for sounds in the frequency range 1 Hz to 850 Hz comprising:
a loudspeaker enclosure; and
a plurality of loudspeaker drivers housed within the loudspeaker enclosure, each loudspeaker driver having one or more cones adapted to direct acoustic energy along an axis and each loudspeaker driver being provided within a separate acoustic channel of the loudspeaker enclosure;
wherein each separate acoustic channel is defined by channel walls running between a respective one of the plurality of loudspeaker drivers and a sound-dispersing area, the sound-dispersing area comprising a plurality of adjacent channel exits;
the axes along which acoustic energy is directed are converging;
each acoustic channel narrowing to a narrowest point located between the loudspeaker driver and the sound-dispersing area, and between the narrowest point and the sound-dispersing area each acoustic channel either widens or is of constant width; and
wherein, at the sound-dispersing area, each of the plurality of adjacent channel exits has a cross-sectional area that is smaller than the cross-sectional surface area, projected along the axis, of the cones of the drivers housed within the respective channel.

9. (canceled)

10. The loudspeaker system of claim 8, wherein the drivers are substantially acoustically equidistant from the sound-dispersing area.

11. The loudspeaker system of claim 8, wherein the drivers are arranged in a substantially symmetric configuration.

12. The loudspeaker system of claim 8, wherein the axes of the drivers converge to intersect at a common point.

13. The loudspeaker system of claim 12, wherein the axes of the drivers converge to intersect at a common point between the drivers and the sound-dispersing area.

14. The loudspeaker system of claim 8, wherein the loudspeaker enclosure is substantially acoustically sealed other than at the sound-dispersing area.

15. The loudspeaker system of claim 8, wherein the drivers are reverse-mounted.

16. The loudspeaker system of claim 8, wherein the loudspeaker system is provided in modular sections, with each section comprising at least one driver.

17. The loudspeaker system of claim 16, wherein each section comprises a plurality of drivers.

18. The loudspeaker system of claim 8, wherein the drivers are arranged in an arc formation, the arc having a concave side and the acoustic channels running between the concave side of the arc and the sound-dispersing area.

19. (canceled)

20. (canceled)

21. The loudspeaker system of claim 8 which comprises a plurality of loudspeaker drivers, wherein the angles between the axes of each pair of adjacent drivers are the same to within 5°.

22. The loudspeaker system of claim 8 which comprises a plurality of loudspeaker drivers, wherein the angles between the axes of each pair of adjacent drivers are substantially identical.

23. (canceled)

24. (canceled)

25. (canceled)

26. (canceled)

27. (canceled)

28. The loudspeaker system of claim 8 wherein the sound-dispersing area is in an end wall of the loudspeaker system, so the sound emerges from the sound-dispersing area in a direction that is substantially orthogonal to the axes of the drivers.

29. A loudspeaker module for sounds in the frequency range 1 Hz to 850 Hz having a loudspeaker enclosure that incorporates a loudspeaker driver coupled to a sound channel that is sealed at each side whilst being acoustically open to the front, the sound channel narrowing to a narrowest point located between the loudspeaker driver and the acoustically open front, and between the narrowest point and the acoustically open front the sound channel either widens or is of constant width.
